(19) United States
(12) Patent Application Publication
(10) Pub. No.: US 2011/0199348 A1
(43) Pub. Date: Aug. 18, 2011

(54) DISPLAY DEVICE AND MANUFACTURING METHOD THEREOF

(75) Inventors: Tomoo Takatani, Osaka-shi (JP); Hiroshi Fukushima, Osaka-shi (JP); Takayuki Yamada, Osaka-shi (JP)

(73) Assignee: SHARP KABUSHIKI KAISHA, Osaka-shi, Osaka (JP)

(21) Appl. No.: 13/122,974

(22) PCT Filed: Jul. 8, 2009
(86) PCT No.: PCT/JP2009/062439

§ 371 Date: Apr. 7, 2011

(30) Foreign Application Priority Data
Oct. 17, 2008 (JP) 2008-268342

(51) Int. Cl. G09G 5/00; H01J 9/24

(52) U.S. Cl. 345/204; 445/24

(57) ABSTRACT

The present invention provides a display device and a manufacturing method thereof with which driver cracks caused by a fall or the like can be suppressed. The display device according to the present invention includes: a display panel; a driver for driving the display panel; a substrate disposed on a display surface side of the display panel; and an adhesive layer for adhering the display panel and the substrate to each other. The driver is provided on an end portion of the display panel between the display panel and the substrate, and a resin member for absorbing an impact is provided between the driver and the substrate.

### TECHNICAL FIELD

The present invention relates to a display device and a manufacturing method thereof, and more particularly to a display device suitable for use as a display device for a portable terminal such as a mobile telephone, a personal digital assistant (PDA), a PDA phone, a portable game console, or a tablet personal computer (PC).

### BACKGROUND ART

Flat panel displays (also referred to as “FPDs” hereafter) that can be provided with a thin profile are currently gaining in popularity as display devices for use in televisions, personal computer displays, portable terminal displays, and so on. Examples of FPDs having practical applications include a liquid crystal display device and a plasma display panel (also referred to as a “PDP” hereafter). Further, examples of FPDs expected to be commercialized and popularized in the future include an organic electroluminescent display device (also referred to as an “organic EL display” hereafter) and a field emission display (also referred to as an “FED” hereafter).

Among these FPDs, the thickness and power consumption of a liquid crystal display device can be reduced easily. Moreover, a liquid crystal display device can be applied to a wide range of screen sizes from a small size to a large size. Therefore, liquid crystal display devices are used in a wide range of applications, including televisions, personal computer displays and portable terminal displays. Display is typically performed in a liquid crystal display device by electrically controlling an alignment direction of liquid crystal sandwiched between a pair of substrates and adjusting an amount of light supplied from a light source such as a backlight.

Further, a display device (to be referred to hereafter as a “first conventional display device”) in which a cover substrate is disposed on a display surface side of a display panel in order to protect the display surface of the display panel and improve the design of the device is being developed as a display device for a portable terminal such as those noted above.

Moreover, a display device (to be referred to hereafter as a “second conventional display device”) in which the display panel and the cover substrate are adhered to each other using a resin adhesive is being developed in a similar field. An electro-optic device formed by sandwiching an electro-optic material between a first substrate and a second substrate has been disclosed as the second conventional display device (see Patent Document 1, for example). In this electro-optic device, a third substrate is adhered to at least one of the first substrate and the second substrate using an adhesive, and a groove is formed in at least one of an area that opposes the third substrate on an adhesion surface of at least one of the first substrate and the second substrate and an area that opposes the at least one substrate on an adhesion surface of the third substrate.

Further, a display device including a display panel and an illumination device for illuminating the display panel has been disclosed with the aim of improving impact resistance in the second conventional display device (see Patent Document 2, for example). In this display device, surfaces of the display panel and the illumination panel respectively opposing a display surface are adhered to each other entirely using a transparent resin.

Patent Document 1: Japanese Kokai Publication No. 2006-58605

Patent Document 2: Japanese Kokai Publication No. 2007-225633

In the first conventional display device, however, the cover substrate is held by a casing of the display device or adhered to the display panel around a peripheral portion alone using double-sided tape, and therefore an air layer exists between the cover substrate and the display panel. As a result, interface reflection may occur on an interface between the cover substrate and the air layer or an interface between the display panel and the air layer, leading to a reduction in a transmittance of the display panel. Further, external light may be reflected by the air layer interface, leading to a reduction in display contrast. Furthermore, the cover substrate is fixed to parts of the display device other than a display area by the double-sided tape or the casing of the display device, and therefore an adhesive strength thereof relative to the display device is weak. Hence, there is room for improvement with regard to vibration resistance and impact resistance.

According to the second conventional display device, on the other hand, a resin having an identical refractive index to a refractive index of the members constituting the cover substrate and the display panel is used as the adhesive, and therefore the transmittance of the display panel can be increased and a reduction in the display contrast caused by external light can be suppressed. Further, the cover substrate and the display panel are adhered by the adhesive over substantially their entire surfaces, and therefore improvements are obtained in the vibration resistance and impact resistance of the display device.

Incidentally, in the first and second display devices described above, a driver is required to drive the display panel. The driver is provided on a substrate end portion of the display panel. Accordingly, the display device is provided with a casing known as a bezel for protecting the driver.

FIG. 5 is a schematic sectional view showing the constitution of the first and second conventional display devices including a bezel. In FIG. 5, a display device 200 includes a liquid crystal display panel 10, a cover substrate 30, an adhesive layer 22 for adhering the display panel 10 and the cover substrate 30 to each other, a driver 37 for driving the liquid crystal display panel 10, and a bezel 70 for protecting the driver 37. The adhesive layer 22 is constituted by double-sided tape in the first conventional display device and an adhesive in the second conventional display device. The liquid crystal display panel 10 is structured such that a TFT array substrate 11 and a color filter substrate (CF substrate) 12 disposed to face each other are adhered to each other via a sealing material (not shown) and a liquid crystal layer is sandwiched between the two substrates. Polarizers 13a, 13b are provided on respective main surfaces of the TFT array substrate 11 and the CF substrate 12 on opposite sides to the liquid crystal layer. The driver 37, a terminal (not shown), and so on are carried on an extension portion 11a of the TFT array substrate 11.

In the conventional display device 200 constituted as described above, a gap d between the driver 37 and the cover substrate 30 has become narrower due to reductions in the thickness, size, and so on of portable terminals. In the first conventional display device, for example, a gap d of approximately 0.5 mm is secured between the driver 37 and the cover substrate 30, whereas in the second conventional display device, the gap d is 0.2 mm at most. As a result, the driver 37 is more likely to contact the cover substrate 30 when the display device 200 receives an impact from a fall or the like. When the driver 37 and the cover substrate 30 come into contact, the driver 37 may be cracked or damaged, causing a “driver crack”. Hence, there remains room for improvement with regard to protection of the driver 37. Furthermore, tempered glass has come into use as a material for the cover substrate 30, and therefore driver cracks are even more likely to occur when the driver 37 contacts the cover substrate 30.

### DISCLOSURE OF THE INVENTION

The present invention has been designed in consideration of the circumstances described above, and an object thereof is to provide a display device and a manufacturing method thereof with which driver cracks caused by a fall or the like can be suppressed.

Following various investigations into a display device that includes a substrate for protecting a display panel and a manufacturing method thereof, the present inventors focused on the gap between the driver and the substrate. The present inventors discovered that when this gap is narrow, the likelihood of contact between the driver and the substrate due to an impact received from a fall or the like increases, but by providing a resin member for absorbing the impact between the driver and the substrate, driver cracks caused by a fall or the like can be suppressed. Thus, the present inventors artfully solved the problems described above, thereby arriving at the present invention.

More specifically, the present invention is a display device including: a display panel; a driver for driving the display panel; a substrate disposed on a display surface side of the display panel; and an adhesive layer for adhering the display panel and the substrate to each other, wherein the driver is provided between an end portion of the display panel and the substrate, and a resin member for absorbing an impact is provided between the driver and the substrate.

The present invention is also a manufacturing method for the display device described above, the manufacturing method including: a through hole forming step of forming the through hole in the substrate in a position facing the end portion of the display panel on which the driver is provided; a resin injecting step of injecting a resin through the through hole to cover at least a surface of the driver that opposes the substrate; and a resin member forming step of forming the resin member by hardening the resin.

The present invention will be described in detail below.

In the present invention, the display panel may be any FPD, such as a liquid crystal display device, a PDP, an organic EL display, or an FED. A display panel of a liquid crystal display device, which may be cited as a representative example of a display panel for an FPD, is structured such that a liquid crystal layer is sandwiched between a TFT array substrate and a CF substrate in a cell formed by adhering the TFT array substrate and the CF substrate to each other via a sealing material, and polarizers are provided on respective main surfaces of the TFT array substrate and the CF substrate on opposite sides to the liquid crystal layer, for example.

The driver drives the display panel, and is provided on the end portion of the display panel between the display panel and the substrate. In the display panel of the liquid crystal display device described above, the driver is carried on the end portion (extension portion) of the TFT array substrate together with a terminal and so on.

The substrate is disposed on the display surface side of the display panel so as to cover at least a display area of the display panel. An area of the substrate corresponding at least to the display area is preferably transparent.

There are no particular limitations on the adhesive layer for adhering the display panel and the substrate to each other, but an adhesive layer that can adhere the display panel and the substrate to each other over substantially their all surfaces is preferable in terms of impact resistance and so on. Further, the adhesive layer is preferably colorless and transparent. When the adhesive layer is colored, display images become colored, and when the adhesive layer is hazy or opaque, blurred display images are provided to a viewer. When the adhesive layer is colorless and transparent, on the other hand, light from the display panel is not colored by the adhesive layer or blocked such that an image display becomes blurred, and therefore the image can be displayed more clearly.

In the display device according to the present invention, a resin member for absorbing an impact is provided between the driver and the substrate. The gap between the driver and the substrate becomes narrower with reductions in the thickness and size of portable terminals, as described above, and as a result, the driver and the substrate are more likely to come into contact when the display device receives an impact from a fall or the like. In the present invention, however, the resin member is provided between the driver and the substrate, and therefore, even if the gap between the driver and the substrate is narrow, the two components do not come into direct contact. Further, when the two components collide via the resin member, the resulting impact can be alleviated by the resin member.

Hence, with the display device according to the present invention, an impact generated by a collision between the driver and the substrate during a fall or the like can be alleviated, and as a result, the occurrence of driver cracks can be suppressed.

As regards the constitution of the display device according to the present invention, as long as the essential constitutional elements described above are provided, other constitutional elements may or may not be included.

At least one through hole is preferably formed in the substrate in a position opposing the end portion of the display panel on which the driver is provided. When this through hole is formed, the through hole can be used to facilitate formation of the resin member during a manufacturing process for manufacturing the display device according to the present invention, to be described below.

The resin member should be provided on the end portion of the display panel between the display panel and the substrate.

To ensure that the effects of the present invention are exhibited reliably and sufficiently, the resin member preferably covers all surfaces of the driver. Thus, an impact generated when the display device is dropped or the like can be alleviated further such that the occurrence of driver cracks is suppressed.

The resin member preferably has a modulus of elasticity of 1×10⁶ Pa or less. The resin member may also be referred to as an impact absorbing member for preventing driver cracks from occurring when the display device receives an impact from a fall or the like such that the driver and the substrate collide. Driver cracks occur because the substrate is harder than the driver. Therefore, to prevent driver cracks, measures are taken to ensure that the driver and the substrate collide via the resin member, which is softer than the substrate, or in other words possesses flexibility. The modulus of elasticity may be used as a specific index of flexibility, and to ensure that the effects of the present invention are exhibited reliably and sufficiently, the modulus of elasticity of the resin member is preferably 1×10⁶ Pa or less, more preferably 1×10⁵ Pa or less, and even more preferably 1×10⁴ Pa or less.

By providing the resin member having this modulus of elasticity, the likelihood of contact between the driver and the substrate when the display device receives an impact from a fall or the like can be reduced even if the gap between the driver and the substrate is narrow. Moreover, even if such contact occurs, the resulting impact can be alleviated. Hence, the occurrence of driver cracks can be suppressed. Further, even when tempered glass is used as the substrate, an impact generated by contact between the driver and the substrate can be alleviated favorably. The modulus of elasticity may be measured using a method described in JIS-K7113 or the like.

There are no particular limitations on the resin for forming the resin member, but a thermosetting resin, a photosetting resin, and so on may be cited as examples thereof. In consideration of the manufacturing method to be described below, the thermosetting resin is preferable. Specific examples of the thermosetting resin include acrylic resins, urethane acrylic resins, and epoxy resins or the like. Ultraviolet curing resins are preferable as the photosetting resin, and an acrylic optical elastic resin (SVR, Super View Resin) or the like proposed by Sony Chemical & Information Device Corporation, Kyoritsu Chemical and co., ltd., and so on may be cited as a specific example thereof.

The substrate may be a cover substrate. A cover substrate is a substrate for protecting the display panel from dust and impacts, and is provided to cover at least the display area. In a typical cover substrate, an area corresponding to the display area is set as a window portion having a light transmitting property, and the periphery of the window portion is set as a black edge portion that is dyed black or the like in order to serve as a light blocking part. Further, the cover substrate is normally positioned on an uppermost layer of the display surface, and therefore, by providing the cover substrate, a display device having a more attractive design can be provided.

The window portion of the cover substrate may be colorless or colored. When the window portion is colorless, the display device 100 can display an image in identical hues to an image displayed by the liquid crystal display panel 10. When the window portion 32 is colored, on the other hand, the display device 100 can display the image displayed by the liquid crystal display panel 10 as an image modified to blue-based hues, red-based hues, and so on, for example.

There are no particular limitations on a planar shape of the cover substrate 30, and a rectangular shape, an elliptical shape, a rectangular shape having rounded angles, a combination of a rectangular shape and an elliptical shape, and so on may be employed. There are also no particular limitations on the planar shapes of the window portion 32 and the black edge portion 31, and these shapes may be set appropriately in accordance with a desired design.

In consideration of the design of the display device, the through hole formed in the substrate may be hidden using a decorative plate, a seal, a logo, or similar. Further, the through hole can be made less obvious by making the color of the resin for forming the resin member identical to the color of the peripheral display panel in which the through hole is formed.

The display panel of the present invention may be a liquid crystal display panel or an organic electroluminescent display panel. Thus, the display device according to the present invention can be used favorably as a portable terminal.

The present invention is also a manufacturing method for the display device of the present invention, the manufacturing method including: a through hole forming step of forming the through hole in the substrate in the position facing the end portion of the display panel on which the driver is provided; a resin injecting step of injecting a resin through the through hole to cover at least a surface of the driver that opposes the substrate; and a resin member forming step of forming the resin member by hardening the resin. According to this manufacturing method, the display device of the present invention, with which the occurrence of driver cracks can be suppressed, can be realized easily.

In the through hole forming step, the through hole may be formed in a plurality as long as at least one through hole is formed in a position opposing the end portion of the display panel on which the driver is provided. Further, there are no particular limitations on the size, shape, and so on of the through hole as long as the resin can be injected through the through hole easily.

Note that in the display device according to the present invention, the resin member may be formed by injecting the resin from the side of the display panel. However, the viscosity of the resin to be injected must be set low, preferably at 1 Pa·s or less, and the resin must be managed on a processing surface so that the resin does not leak out and stain a backlight or the like. Hence, the manufacturing process is complicated. In the present invention, driver protection can be realized through a simple process of injecting the resin through the through hole formed in the substrate, as described above.

In the resin injecting step, it is sufficient for the resin injected through the through hole to cover at least the surface of the driver that opposes the substrate so that the driver provided on the substrate end portion is protected, and all surfaces of the driver may be covered. Moreover, the resin may be injected into the entirety of a space formed between the display panel and the substrate. Note that since this space is extremely small, resin leakage from the display panel can be suppressed by adjusting the viscosity of the resin to be injected. Further, when the viscosity of the resin is low, the gap between the display panel and the substrate may be covered by a protective member or the like in order to prevent the resin from flowing out. This protective member or the like may be removed once the resin has hardened.

In the manufacturing method for a display device according to the present invention, a thermosetting resin is preferably used as the resin, and in the resin member forming step, the resin is preferably hardened by applying heat thereto. A photosetting resin may also be used as the resin for forming the resin member, but depending on the color, material, and so on of the substrate, it may be impossible to irradiate the injected resin with sufficient light. When a thermosetting resin is used, on the other hand, the resin can be hardened easily by applying heat, and therefore the resin member can be formed more easily. As a result, the display device according to the present invention can be manufactured with favorable productivity, and the driver can be covered (fixed) more easily.

The resin preferably has a viscosity of 1 to 4 Pa·s (1000 to 4000 cps) and a post-hardening modulus of elasticity of 1×10⁶ Pa or less. When the viscosity of the resin injected into the through hole in the resin injecting step is lower than 1 Pa·s, it becomes difficult to form the resin member, and when the viscosity of the resin exceeds 4 Pa·s, it becomes difficult to inject the resin into the through hole. The modulus of elasticity of the hardened resin is as described above.

Further, the adhesive layer for adhering the substrate and the display panel to each other may be formed using a thermosetting resin. In this type of display device, the adhesive layer and the resin forming the resin member can be hardened at the same time, enabling a further improvement in productivity.

The manufacturing method for a display device according to the present invention is not limited as far as the method includes the steps described above. The manufacturing method may include other steps.

### EFFECT OF THE INVENTION

With the display device and the manufacturing method thereof according to the present invention, driver cracks caused by a fall or the like can be suppressed.

### BRIEF DESCRIPTION OF THE DRAWINGS

FIG. 1 is a schematic sectional view showing the constitution of a display device according to Embodiment 1 of the present invention, wherein FIG. 1(a) is an overall view and FIG. 1(b) is an enlarged view of an area surrounded by a broken line in FIG. 1(a).

FIG. 2 is a schematic plan view of a cover substrate according to Embodiment 1 of the present invention.

FIG. 3 is a schematic plan view of the display device according to Embodiment 1 of the present invention.

FIGS. 4(a) to 4(d) are schematic sectional views illustrating manufacturing processes of the display device according to Embodiment 1 of the present invention.

FIG. 5 is a schematic sectional view showing the constitution of a conventional display device.

### BEST MODES FOR CARRYING OUT THE INVENTION

Citing embodiments, the present invention will be described in further detail below with reference to the drawings. However, the present invention is not limited to these embodiments alone.

### Embodiment 1

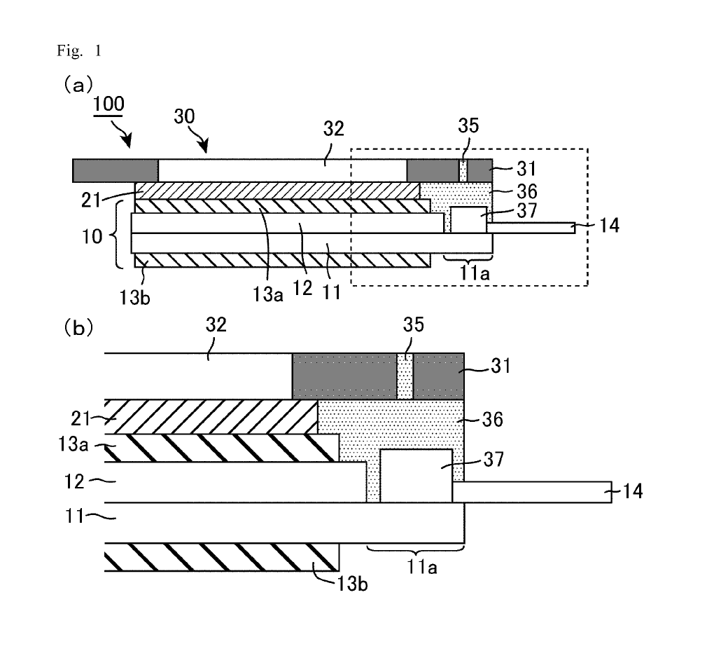

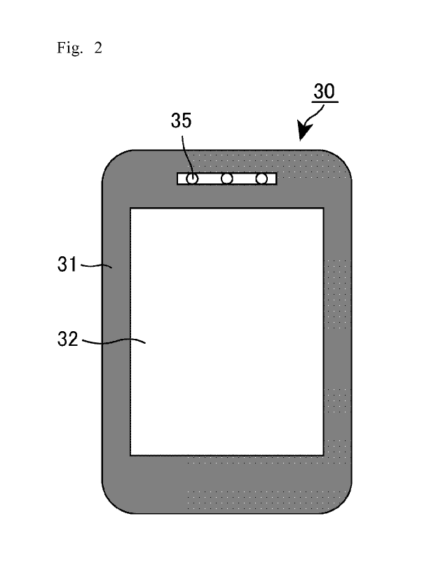

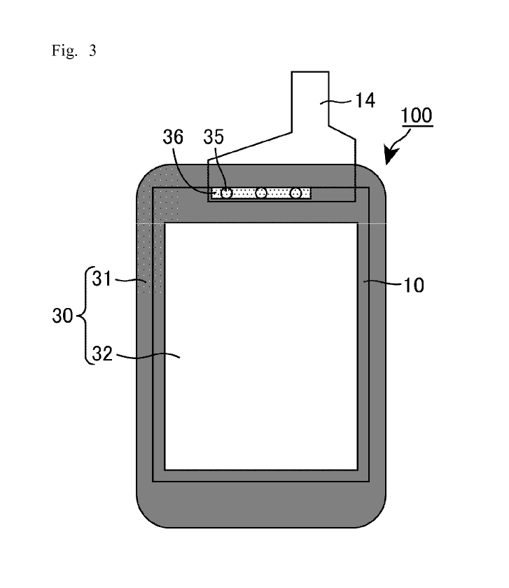

FIG. 1 is a schematic sectional view showing a display device according to Embodiment 1 of the present invention, wherein FIG. 1(a) is an overall view of the display device and FIG. 1(b) is an enlarged view of an area surrounded by a broken line in FIG. 1(a). FIG. 2 is a schematic plan view of a cover substrate according to Embodiment 1 of the present invention. FIG. 3 is a schematic plan view of the display device according to Embodiment 1 of the present invention.

In FIG. 1(a), a display device 100 is a liquid crystal display device including a liquid crystal display panel 10, a cover substrate 30 disposed on a display surface side of the liquid crystal display panel 10, an adhesive layer 21 provided between the liquid crystal display panel 10 and the cover substrate 30, a backlight unit (not shown) disposed on a back surface side of the liquid crystal display panel 10, and a casing (not shown) holding these constitutional members. In other words, the display device 100 is structured such that the liquid crystal display panel 10 and the cover substrate 30 are adhered to each other by the adhesive layer 21.

Here, the liquid crystal display panel 10 is an active matrix type liquid crystal display panel in which pixels are arranged in matrix form. The liquid crystal display panel 10 includes a TFT array substrate 11, a color filter substrate (CF substrate) 12, and a sealing material (not shown) adhering the two substrates to each other. The TFT array substrate 11 and the CF substrate 12 are disposed to face each other and adhered by the sealing material such that a predetermined interval is maintained. A liquid crystal material (not shown) is charged into an empty panel formed thereby. Hence, the liquid crystal display panel 10 is structured such that a liquid crystal layer is sandwiched between the TFT array substrate 11 and the CF substrate 12.

Note that the sealing material is a member for sealing the liquid crystal layer between the TFT array substrate 11 and the CF substrate 12, and is disposed in an area other than a display area for displaying images, i.e. a non-display area. There are no particular limitations on the sealing material and the material of the liquid crystal layer, and these materials may be selected appropriately.

In the TFT array substrate 11, a thin film transistor (TFT) serving as a switching element, a pixel electrode, bus wirings such as data wirings and scanning wirings, an alignment layer, and so on are provided on a liquid crystal layer side of a colorless transparent insulating substrate as constitutional elements of a display element of the liquid crystal display panel 10. Further, as shown in FIG. 1(a), the TFT array substrate 11 includes an extension portion 11a extending from the CF substrate 12, and a terminal (not shown) is provided on this extension portion. Furthermore, an FPC (flexible printed circuit) substrate 14 carrying a driver 37 and so on is connected to the extension portion 11a.

Meanwhile, in the CF substrate 12, members such as a black matrix (BM), red, blue and green color filters, a common electrode, and an alignment layer are provided on a liquid crystal layer side of a colorless transparent insulating substrate.

There are no particular limitations on the material of the insulating substrates constituting the TFT array substrate 11 and the CF substrate 12, and materials such as glass and resin (plastic) are preferable due to their superior light transmitting property and workability.

Further, polarizers 13a, 13b are provided on respective main surfaces of the TFT array substrate 11 and the CF substrate 12 on opposite sides to the liquid crystal layer. The polarizers 13a, 13b are constructed by sandwiching a polarizer formed from a polyvinyl alcohol (PVA)-based film on which an iodine complex or a dichroic dye is adsorbed between protective layers formed from a cellulose-based polymer such as triacetyl cellulose (TAC). Note that a viewing angle compensation film such as a phase difference plate may be disposed between the TFT array substrate 11 and/or the CF substrate 12 and the polarizer.

The adhesive layer 21 is provided over substantially the entire surface of an area in which the liquid crystal display panel 10 and the cover substrate 30 oppose each other. As a result, improvements in the vibration resistance and impact resistance of the display device 100 are achieved. Further, the adhesive layer 21 is a colorless transparent layer formed from a hardened adhesive, and therefore a viewer can view an image displayed on the liquid crystal display panel 10 clearly. The adhesive may be a thermosetting resin and/or a photosetting resin. A haze of the adhesive layer 21 is preferably 3% or less (more preferably 1% or less).

Furthermore, a refractive index of the adhesive layer 21 is aligned with a refractive index of the material (glass, resin, etc.) of the cover substrate 30 and a refractive index of the protective layer of the polarizer 13a. More specifically, the refractive indexes of the adhesive layer 21, the cover substrate 30, and the protective layer of the polarizer 13a are set at approximately 1.48 to 1.52. Thus, light reflection on an interface between the adhesive layer 21 and the liquid crystal display panel 10 and an interface between the adhesive layer 21 and the cover substrate 30 can be suppressed. As a result, a light transmittance of the display device 100 can be increased, and a reduction in a display contrast caused by external light can be suppressed.

Further, a gap between the liquid crystal display panel 10 and the cover substrate 30, or in other words the thickness of the adhesive layer 21, is set to be no smaller than 50 μm (preferably no smaller than 100 μm). Thus, the adhesive layer 21 can be caused to function effectively as a buffer layer for alleviating pressure and impacts. As a result, pressure generated on the cover substrate 30 side by a human finger and an impact generated when an object falls onto the cover substrate 30 can be prevented from acting directly on the liquid crystal display panel 10.

Further, a storage elastic modulus of the adhesive layer 21 at 23° C. is set at 1.0×10³ to 1.0×10⁶ Pa. When the adhesive contains resin, uneven shrinkage occurs between an outer peripheral part and an inner central part of the adhesive layer as the adhesive hardens, and therefore internal stress is likely to occur in the adhesive layer. As a result, a cell thickness of the liquid crystal display panel may be affected, and display unevenness may occur on the edge of the display area. In this Embodiment, however, the storage elastic modulus of the adhesive layer 21 is set as described above, and therefore internal stress can be absorbed effectively by an elasticity of the adhesive layer 21 itself. Hence, a display quality of the display device 100 can be improved.

The cover substrate 30 is a substrate for protecting the liquid crystal display panel 10 from dust and impacts, and is provided to cover at least the display area. The cover substrate 30 will now be described in detail using FIG. 2.

In FIG. 2, the cover substrate 30 includes a window portion 32 serving as a light transmitting part formed to correspond to the display area, and a black edge portion 31 serving as a light blocking part provided on the periphery of the window portion. The window portion 32 and the black edge portion 31 are constituted by an integrated member. The window portion 32 is formed from a transparent member made of glass, resin, or the like, and the black edge portion 31 is formed by dyeing this transparent member. The cover substrate 30 is therefore provided with an attractive design, enabling an improvement in the design of the display device 100. Moreover, unsightly parts disposed on the outer edge of the liquid crystal display panel 10, such as the terminal, wirings, and so on, can be hidden effectively by the black edge portion 31.

At least one through hole 35 is formed in the cover substrate 30 according to this Embodiment in a position opposing an end portion of the liquid crystal display panel 10 on which the driver 37 is provided. Here, three through holes 35 are formed.

As shown in FIGS. 1(a), 1(b) and FIG. 3, a resin member 36 is formed in the display device 100 including the cover substrate 30 by charging resin through the through holes 35 and hardening the resin. Here, the resin member 36 is formed by charging the resin into the entire gap between the extension portion 11a of the TFT array substrate 11 and the cover substrate 30, and therefore all surfaces of the driver 37 are covered by the resin member 36.

By covering all of the surfaces of the driver 37 with the resin member 36 in this manner, the driver 37 is protected by the resin member 36 when the display device 100 is dropped or the like, and therefore driver cracks can be reduced.

In the above description, the through holes 35 are formed in a plurality in the cover substrate 30. However, the present invention is not limited to this example, and a single through hole 35 may be formed in the cover substrate 30.

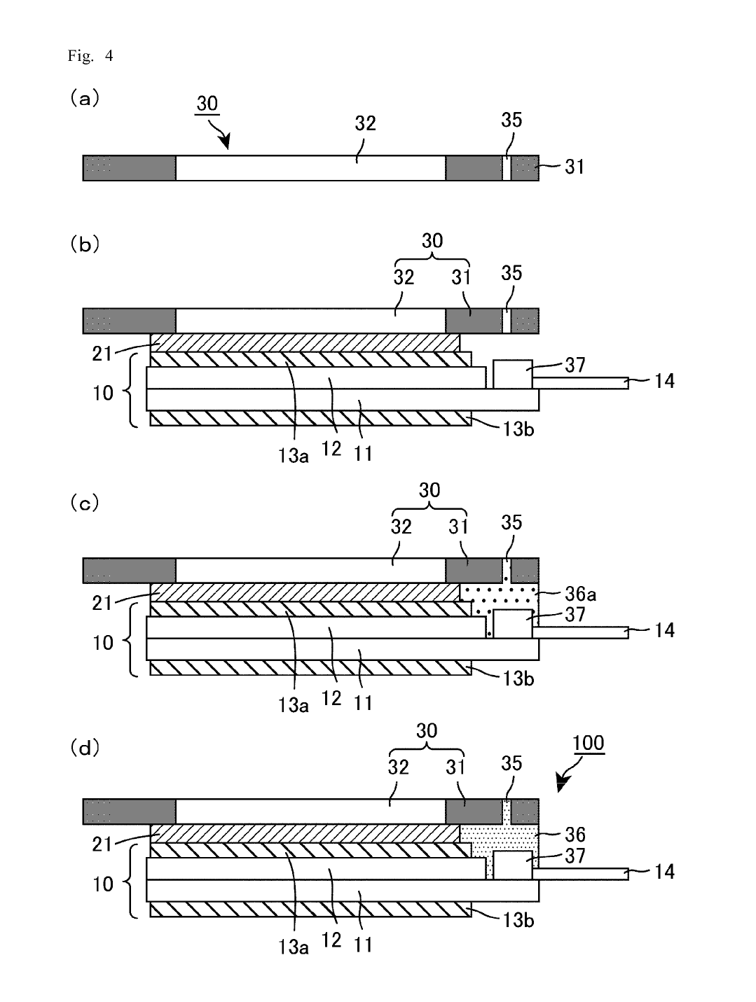

Referring to FIG. 4, a manufacturing method for the display device according to Embodiment 1 will be described below. FIGS. 4(a) to 4(d) are schematic sectional views illustrating manufacturing processes of the display device according to Embodiment 1.

FIG. 4(a) is a schematic sectional view showing the cover substrate 30 in a state where the through hole 35 has been formed in a through hole formation process. The cover substrate 30 includes the window portion 32 and the black edge portion 31. There are no particular limitations on the material of the cover substrate 30 as long as it is transparent and possesses a certain degree of strength. Especially, glass, tempered glass, resin, and so on may be applied, and in consideration of the ease of forming the through holes 35 and so on, glass and resin are preferable.

There are no particular limitations on a method of forming the black edge portion 31, in particular a method of printing black ink onto a main surface of the cover substrate 30 on the adhesive layer 21 side is preferable. Note that the cover substrate 30 may be provided with an edge portion of a color other than black or an edge portion of a plurality of colors.

In the through hole formation process, the through hole 35 is formed in the cover substrate 30 constituted as described above in a position opposing the end portion of the liquid crystal display panel 10 on which the driver 37 is provided.

FIG. 4(b) shows a state obtained when the cover substrate 30 formed with the through hole 35 is adhered to the liquid crystal display panel 10 via the adhesive layer 21. The liquid crystal display panel 10 is constructed using a typical method.

There are no particular limitations on a liquid crystal mode of the liquid crystal display panel 10, and various modes, such as a TN (Twisted Nematic) mode, an IPS (In Plane Switching) mode, and a VATN (Vertical Alignment Twisted Nematic) mode may be applied. Further, the liquid crystal display panel 10 may have a multi-domain structure. Moreover, the liquid crystal display panel 10 may be any of a transmission type display panel, a reflection type display panel, and a transflective (both reflection and transmission) type display panel.

An arrangement relationship between polarization axes of the polarizers 13a, 13b provided in the liquid crystal display panel 10 is set in accordance with the liquid crystal mode. Normally, the polarizers 13a, 13b are disposed in a cross nicol arrangement or a parallel nicol arrangement. Thus, when the FPC substrate 14 is connected to the liquid crystal display panel 10, a liquid crystal display module is constructed.

The adhesive layer 21 is formed by applying an adhesive to a predetermined position and then hardening the adhesive. The adhesive may be applied to the polarizer 13a formed on the main surface of the CF substrate 12 of the liquid crystal display panel 10, to the cover substrate 30, or to both the polarizer 13a and the cover substrate 30. More specifically, for example, the adhesive is applied to the polarizer 13a of the liquid crystal display panel 10 at a thickness of approximately 50 to 200 μm using a nozzle such as a slit coater.

Next, the cover substrate 30 is adhered to the liquid crystal display panel 10 via the adhesive under atmospheric pressure or a reduced pressure of 10 Pa or less, whereupon the cover substrate 30 is pressurized by a pressurizing means to control the gap between the liquid crystal display panel 10 and the cover substrate 30 to a desired value. There are no particular limitations on the applied pressure, and the applied pressure may be set at approximately 50 kPa, for example. Next, the liquid crystal display panel 10 and the cover substrate 30 are aligned by moving the cover substrate 30 in a horizontal direction using a position adjusting means such as a chuck. The liquid crystal display panel 10 and cover substrate 30 are then held in an appropriate position for approximately 10 minutes until hardening of the adhesive is complete. As a result, the cover substrate 30 is fixed to the liquid crystal display panel 10.

FIG. 4(c) is a schematic sectional view showing a state obtained when resin 36a is injected through the through hole 35 in the cover substrate 30 in a resin injection process. The molten resin 36a is injected using a jig such as a dispenser. A viscosity of the molten resin 36a is 3 Pa·s.

The injected resin 36a covers at least the surface of the driver 37 that opposes the cover substrate 30. Here, the resin 36a covers all surfaces of the driver 37. Note that in FIG. 4(c), the space between the cover substrate 30 and the liquid crystal display panel 10 is enlarged for convenience, but in actual fact the space is extremely small, and therefore the resin can be injected through the through hole 35 without flowing out to the exterior of the liquid crystal display panel 10.

FIG. 4(d) shows a state obtained when the resin 36a is hardened to form the resin member 36 in a resin member formation process. In the resin member formation process, the resin 36a is hardened by applying heat. As a result, the resin member 36 is formed, and thus the display device 100 according to the present invention is formed. A modulus of elasticity of the resin member 36 is 1×10⁶ Pa. The modulus of elasticity was measured on the basis of a method described in JIS-K7113.

The liquid crystal display module in which the cover substrate 30 is adhered to the liquid crystal display panel 10 is then combined with a backlight unit, a casing, and so on to form the display device 100. Note that a typical constitution such as a light source, a reflector, an optical sheet, or the like may be employed as the backlight unit. Further, the backlight unit may be a direct unit or an edge light type unit.

According to this Embodiment, as described above, the resin member 36 is formed between the driver 37 and the cover substrate 30, and therefore cracks in the driver 37 can be reduced. As a result, improvements in the reliability and productivity of the display device 100 can be achieved.

A following drop test was performed using the display device 100 constituted as described above.

(Drop Test)

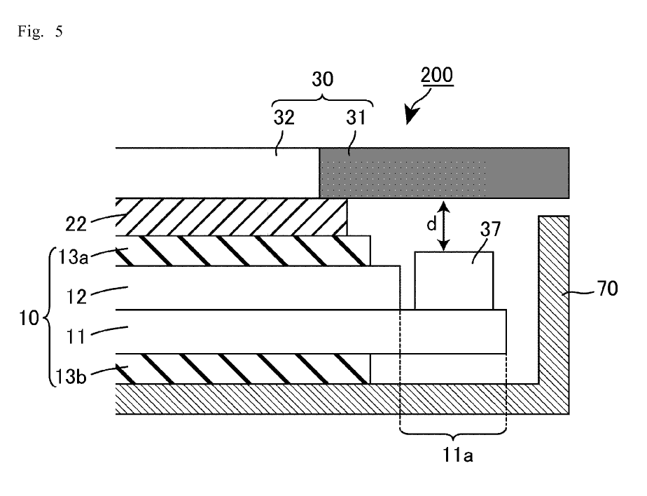

In a room temperature (25° C.) atmosphere, the display device 100 was allowed to fall freely from a height of 50 cm, and the presence of driver cracks was determined. This operation was performed on five display devices 100. Those in which driver cracks did not appear after the fall were evaluated with +, and those in which a driver crack appeared were evaluated with −. A similar test was performed after modifying the falling height of the display device 100 to 60 cm and 70 cm. Further, as a comparative embodiment, a similar test was performed using the conventional display device shown in FIG. 5, in which the resin member 36 is not provided.

Table 1 shows obtained measurement results.

TABLE 1

| Fall position | Embodiment | | | | | Comparative Embodiment | | | | |
|---|---|---|---|---|---|---|---|---|---|---|
| 50 cm | + | + | + | + | + | + | + | + | + | + |
| 60 cm | + | + | + | + | + | + | − | + | + | − |
| 70 cm | + | + | + | + | + | − | − | − | − | − |

As is evident from Table 1, driver cracks did not occur in the display device 100 according to this Embodiment when the display device 100 was dropped from heights of 50 cm, 60 cm, and 70 cm. In the comparative embodiment not provided with the resin member 36, on the other hand, although driver cracks did not occur at a falling height of 50 cm, a driver crack occurred in two of the five display devices when dropped from a height of 60 cm and in all five display devices when dropped from a height of 70 cm.

Hence, it is evident that with the display device 100 according to this Embodiment of the present invention, the occurrence of driver cracks caused by a fall or the like can be suppressed, and therefore superior impact resistance can be obtained. Moreover, in contrast to a conventional display device, a bezel or the like for protecting the driver 37 is not required, and therefore further reductions in the thickness and size of the display device can be achieved.

Note that in the above description, a thermosetting resin is used as the resin for forming the resin member 36, but the present invention is not limited thereto, and when the light-permeable cover substrate 30 is used for the black edge portion 31, a photosetting resin, for example, may be used instead. An ultraviolet curing resin is preferably employed as the photosetting resin. More specifically, an acrylic optical elastic resin (SVR) or the like proposed by Sony Chemical & Information Device Corporation, Kyoritsu Chemical and co., ltd., and so on may be used favorably.

Further, in the above description, the resin for forming the resin member 36 is injected through the through hole 35 formed in the cover substrate 30, but the present invention is not limited thereto, and the resin may be injected from a side portion of the driver 37, for example. Further, the resin member 36 may be provided in advance on the upper portion and so on of the driver 37. Note, however, that as display devices gradually become thinner and smaller, the gap between the substrate and the driver 37 narrows, making it more difficult to inject the resin from the side portion of the driver 37, and in this case it may also be difficult to form the resin member 36 in advance on the upper portion and so on of the driver 37. As a result, the resin member 36 cannot be formed as easily as with the manufacturing method according to the present invention, described above.

Furthermore, in the above description, an active matrix type liquid crystal display panel is cited as an example of the liquid crystal display panel 10, but the present invention is not limited thereto, and various types of liquid crystal display panel 10 may be used.

Further, in the display device 100 according to this Embodiment, an organic EL panel, a PDP, or an FED panel may be used as the display panel instead of the liquid crystal display panel 10. The display device 100 may be an organic EL display, a PDP, or an FED, the display device 100 is preferably a liquid crystal display device or an organic EL display in particular. Thus, the display device 100 can be used favorably as a portable terminal.

Hence, there are no particular limitations on the display panel of the display device 100, and any display panel in which the display area is constituted by pixels arranged in matrix form may be employed. Accordingly, a simple matrix type system may be used as a driving system for the liquid crystal display panel 10 described above.

Further, when an organic EL display is applied to the display panel of the display device 100, the display panel of the display device 100 may be constructed using display elements constituted by an electrode, an organic thin film containing a light emitting material, and so on, rather than display elements using liquid crystal.

Furthermore, when a PDP is applied to the display panel of the display device 100, the display panel of the display device 100 may be constructed using display elements constituted by an electrode, a dielectric material, a noble gas, a fluorescent material, and so on, rather than display elements using liquid crystal.

Furthermore, when an FED is applied to the display panel of the display device 100, the display panel of the display device 100 may be constructed using display elements constituted by a microchip, a gate electrode, a fluorescent material, and so on, rather than display elements using liquid crystal.

Further, in the above description, the adhesive layer 21 is formed using an adhesive, but the present invention is not limited thereto, and a resin member may be formed similarly in a display device in which the adhesive layer 21 is formed from double-sided tape or the like.

The present application claims priority under the Paris Convention and the laws of transient countries based on Japanese Patent Application No. 2008-268342 filed on Oct. 17, 2008. The entirety of the content of the file is integrated into this application as reference.

### EXPLANATION OF REFERENCE NUMERALS

10 liquid crystal display panel
11 TFT array substrate
11a extension portion
12 CF substrate
13a, 13b polarizer
14 FPC substrate
21 adhesive layer (hardened adhesive)
22 adhesive layer
30 cover substrate
31 black edge portion (light blocking part)
32 window portion (light transmitting part)
35 injection port
36 resin member
36a resin (unhardened)
37 driver
40 nozzle
70 bezel
100, 200 display device

1. A display device comprising:
a display panel;
a driver for driving the display panel;
a substrate disposed on a display surface side of the display panel; and
an adhesive layer for adhering the display panel and the substrate to each other,
wherein the driver is provided between an end portion of the display panel and the substrate, and
a resin member for absorbing an impact is provided between the driver and the substrate.

2. The display device according to claim 1,
wherein at least one through hole is formed in the substrate in a position opposing the end portion of the display panel on which the driver is provided.

3. The display device according to claim 1,
wherein the resin member covers all surfaces of the driver.

4. The display device according to claim 1,
wherein the resin member has a modulus of elasticity of 1×10⁶ Pa or less.

5. The display device according to claim 1,
wherein the substrate is a cover substrate.

6. The display device according to claim 1,
wherein the display panel is a liquid crystal display panel or an organic electroluminescent display panel.

7. A manufacturing method for the display device according to claim 1,
wherein the manufacturing method comprises:
a through hole forming step of forming the through hole in the substrate in a position facing the end portion of the display panel on which the driver is provided;
a resin injecting step of injecting a resin through the through hole to cover at least a surface of the driver that opposes the substrate; and
a resin member forming step of forming the resin member by hardening the resin.

8. The manufacturing method for a display device according to claim 7,
wherein a thermosetting resin is used as the resin, and
in the resin member forming step, the resin is hardened by applying heat thereto.

9. The manufacturing method for a display device according to claim 7,
wherein the resin has a viscosity of 1 to 4 Pa·s and a post-hardening modulus of elasticity of 1×10⁶ Pa or less.
